(19) United States
(12) Patent Application Publication
(10) Pub. No.: US 2026/0131633 A1
(43) Pub. Date: May 14, 2026

(54) VEHICLE HVAC SYSTEM

(71) Applicants: Hyundai Motor Company, Seoul (KR); Kia Corporation, Seoul (KR); Doowon Climate Control Co., Ltd., Asan-si (KR)

(72) Inventors: Sung Hyun Moon, Hwaseong-si (KR); Tae Han Kim, Hwaseong-si (KR); Jae Hyun Song, Hwaseong-si (KR); Jong Moon Won, Hwaseong-si (KR); Hwan Yeui Hong, Hwaseong-si (KR); Min Gyu Lee, Hwaseong-si (KR); Chul Min Kim, Asan-si (KR)

(21) Appl. No.: 19/185,574

(22) Filed: Apr. 22, 2025

(30) Foreign Application Priority Data
Nov. 12, 2024 (KR) 10-2024-0160361

(51) Int. Cl. B60H 1/00

(52) U.S. Cl. CPC B60H 1/00914; B60H 1/00278; B60H 1/00485

(57) ABSTRACT

A vehicle heating, ventilation, and air conditioning (HVAC) system can include a compressor, an interior condenser disposed on the downstream side of the compressor, a heat exchanger disposed on the downstream side of the interior condenser, and configured to transfer heat between a refrigerant and a coolant circulating in a coolant system, an evaporator disposed on the downstream side of the heat exchanger, and disposed on the upstream side of the compressor, a first bypass line connecting a downstream point of the heat exchanger and an upstream point of the compressor, and a second bypass line connecting a downstream point of the interior condenser and an upstream point of the evaporator.

### CROSS-REFERENCE TO RELATED APPLICATIONS

This application is based on and claims the benefit of priority to Korean Patent Application No. 10-2024-0160361, filed on Nov. 12, 2024, in the Korean Intellectual Property Office, the disclosure of which is incorporated herein in its entirety by reference.

### TECHNICAL FIELD

The present disclosure relates to a vehicle heating, ventilation, and air conditioning (HVAC) system.

### BACKGROUND

In recent years, with a growing interest in energy efficiency and environmental issues, there is a demand for development of eco-friendly vehicles that can replace internal combustion engine vehicles. Such eco-friendly vehicles are classified into electric vehicles which are driven using fuel cells or electricity as a power source and hybrid vehicles which are driven using an engine and a battery.

Electric vehicles or hybrid vehicles may include a heating, ventilation, and air conditioning (HVAC) system for air conditioning in a cabin (or passenger compartment). The HVAC system may be configured to heat and cool the air in the cabin for passenger comfort.

To ensure driving safety, electric vehicles or hybrid vehicles may include a power electronics (PE) cooling system to maintain PE components of a PE system at appropriate temperatures, and a battery cooling system to maintain a battery at an appropriate temperature. The PE cooling system may cool the PE components such as an electric motor, an inverter, an on-board charger (OBC), and a low DC-DC converter (LDC), thereby keeping the PE components at their respective appropriate temperatures. The battery cooling system may cool the battery, thereby keeping the battery at its appropriate temperature.

A refrigerant circulating in the HVAC system of the electric vehicle may be configured to absorb heat from a PE coolant circulating in the PE cooling system through a water-cooled heat exchanger and be evaporated.

However, in a condition in which an ambient temperature is relatively low (for example, −20° C.-−5° C.), the temperature of the PE coolant may be relatively lowered, and accordingly the refrigerant may fail to sufficiently absorb heat from the PE coolant. As a result, the evaporation of the refrigerant may be reduced, and a suction pressure of a compressor may be lowered below a threshold pressure. When the suction pressure of the compressor is lower than the threshold pressure (for example, 0.2 kgf/cm₂), efficiency of the compressor may be reduced, and accordingly RPM of the compressor may be lowered below threshold RPM or the compressor may be stopped due to a low pressure protection function. As a result, the flow rate of the refrigerant may be relatively reduced, and the temperature of the refrigerant discharged from the compressor may be relatively lowered so that the coefficient of performance (COP) of the HVAC system may be degraded. As the heating of the cabin with the use of the refrigerant is not smoothly performed, but the heating of the cabin is performed by an electric heater, electric efficiency of the electric vehicle may be reduced.

In the HVAC system according to the related art, as the heat absorption of the refrigerant is reduced in a condition in which the ambient temperature is relatively low, the suction pressure of the compressor may be relatively lowered. Accordingly, the heating of the cabin with the use of the refrigerant may not be smoothly performed due to the RPM reduction or stop of the compressor, and the cabin may be heated by the electric heater so that the electric efficiency of the electric vehicle may be reduced.

The above information described in this background section is provided to assist in understanding the background of the present disclosure, and may include technical concepts that are not considered as prior art that is already publicly known, available, or in use.

### SUMMARY

The present disclosure relates to a vehicle heating, ventilation, and air conditioning (HVAC) system, and more particularly, to a vehicle HVAC system designed to improve heating performance using a refrigerant, thereby improving electric efficiency of an electric vehicle.

An embodiment of the present disclosure can solve the above-mentioned problems occurring in the prior art while advantages achieved by the prior art are maintained intact.

An embodiment of the present disclosure can provide a vehicle heating, ventilation, and air conditioning (HVAC) system designed to improve heating performance using a refrigerant, thereby improving electric efficiency of an electric vehicle.

According to an embodiment of the present disclosure, a vehicle HVAC system may include: a compressor; an interior condenser disposed on the downstream side of the compressor; a heat exchanger disposed on the downstream side of the interior condenser, and configured to transfer heat between a refrigerant and a coolant circulating in a coolant system; an evaporator disposed on the downstream side of the heat exchanger, and disposed on the upstream side of the compressor; a first bypass line connecting a downstream point of the heat exchanger and an upstream point of the compressor; and a second bypass line connecting a downstream point of the interior condenser and an upstream point of the evaporator.

The vehicle HVAC system may further include an exterior heat exchanger disposed between the heat exchanger and the evaporator, and configured to transfer heat between the refrigerant and ambient air. The first bypass line may be configured to allow at least a portion of the refrigerant discharged from the heat exchanger to be directed from an upstream point of the exterior heat exchanger to the upstream point of the compressor.

The vehicle HVAC system may further include: a cooling-side expansion valve disposed between the exterior heat exchanger and the evaporator; and a heating-side expansion valve disposed between the heat exchanger and the interior condenser. The second bypass line may be configured to allow at least a portion of the refrigerant discharged from the interior condenser to be directed from an upstream point of the heating-side expansion valve to the upstream point of the evaporator.

The vehicle HVAC system may further include a control valve configured to control the flow of the refrigerant in a manner that allows the refrigerant discharged from the heat exchanger to be directed to at least one of the exterior heat exchanger and the compressor.

The control valve may include an inlet port communicating with the heat exchanger, a first outlet port communicating with the exterior heat exchanger, and a second outlet port communicating with the first bypass line.

The control valve may be switched to allow the inlet port to be fluidly connected to at least one of the first outlet port and the second outlet port.

The control valve may be switched to allow the inlet port to be fluidly connected to the second outlet port when the HVAC system operates in a heating mode.

The vehicle HVAC system may further include an auxiliary expansion valve disposed on the second bypass line. The auxiliary expansion valve may be disposed on the upstream side of the evaporator on the second bypass line.

The auxiliary expansion valve may be fully opened when the HVAC system operates in a heating mode.

The vehicle HVAC system may further include an adjusting valve disposed between the evaporator and the compressor. The adjusting valve may adjust an opening degree thereof to adjust a flow rate of the refrigerant discharged from the evaporator.

The heat exchanger may include a first passage through which the refrigerant passes, and a second passage through which the coolant passes. The second passage of the heat exchanger may be fluidly connected to a power electronics (PE) coolant system.

### BRIEF DESCRIPTION OF THE DRAWINGS

The above and other features and advantages of example embodiments of the present disclosure can be more apparent from the following detailed description taken in conjunction with the accompanying drawings, in which:

FIG. 1 illustrates a vehicle heating, ventilation, and air conditioning (HVAC) system according to an example embodiment of the present disclosure;

FIG. 2 illustrates a flow of a refrigerant when a vehicle HVAC system according to an example embodiment of the present disclosure operates in a heating mode;

FIG. 3 illustrates a flow of a refrigerant when a vehicle HVAC system according to an example embodiment of the present disclosure operates in a cooling mode; and

FIG. 4 illustrates a flow of a refrigerant when a vehicle HVAC system according to an example embodiment of the present disclosure operates in an after-blow mode.

### DETAILED DESCRIPTION OF ILLUSTRATIVE EMBODIMENTS

Hereinafter, example embodiments of the present disclosure will be described in detail with reference to the accompanying drawings. In the drawings, same reference numerals can be used throughout to designate same or equivalent elements. A detailed description of well-known techniques associated with the present disclosure can be ruled out to not unnecessarily obscure the gist of the present disclosure.

Terms such as “first,” “second,” “A,” “B,” “(a),” and “(b)” may be used to describe the elements in example embodiments of the present disclosure. These terms can be used merely to distinguish one element from another element, and the intrinsic features, sequence or order, and the like of the corresponding elements are not necessarily limited by these terms. Unless otherwise defined, terms used herein, including technical or scientific terms, can have same meanings as those generally understood by those with ordinary knowledge in the field of art to which the present disclosure belongs. Such terms as those defined in a generally used dictionary can be interpreted as having meanings equal to the contextual meanings in the relevant field of art.

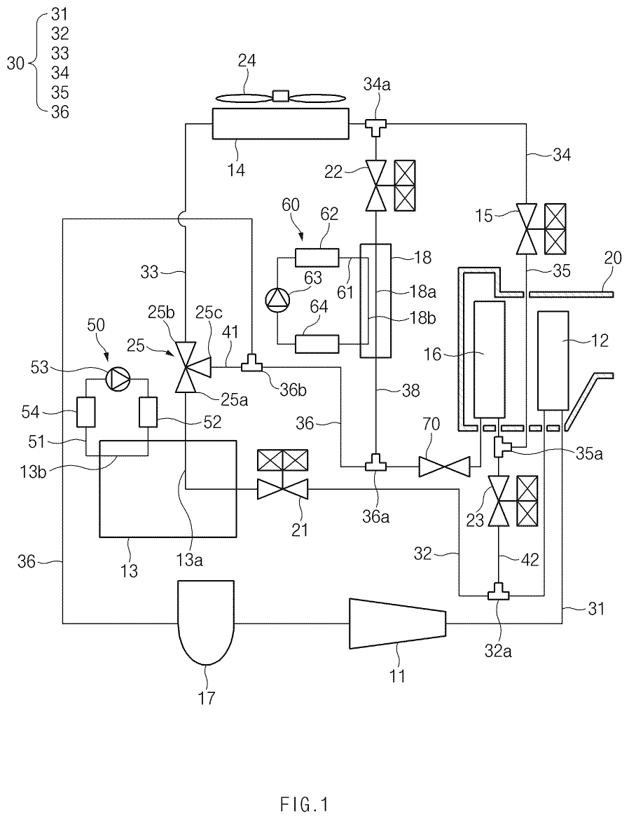

Referring to FIG. 1, a vehicle heating, ventilation, and air conditioning (HVAC) system according to an example embodiment of the present disclosure may be configured to heat and cool air in a cabin (or passenger compartment) of the vehicle through a phase change of a circulating refrigerant. The HVAC system may include a refrigerant circulation path 30 through which a refrigerant is allowed to circulate, and an HVAC case 20. The refrigerant circulation path 30 may be fluidly connected to a compressor 11, an interior condenser 12, a heat exchanger 13, an exterior heat exchanger 14, a cooling-side expansion valve 15, and an evaporator 16. The refrigerant circulation path 30 may allow the flow of the refrigerant to vary depending on various operating modes of a vehicle thermal management system.

The compressor 11 may compress the refrigerant and allow the refrigerant to circulate. In particular, the compressor 11 may be configured to compress the refrigerant received from the evaporator 16 and/or a battery chiller 18. The compressor 11 may include a compressor motor and a compression section operated by the compressor motor. The refrigerant circulation path 30 may be fluidly connected to the compression section of the compressor 11.

The HVAC system may include an accumulator 17 disposed on the upstream side of the compressor 11. The accumulator 17 may be located between the evaporator 16 and the compressor 11, and the accumulator 17 may separate a liquid refrigerant from the refrigerant received from the evaporator 16, thereby preventing the liquid refrigerant from flowing into the compressor 11.

The interior condenser 12 may be disposed on the downstream side of the compressor 11, and be configured to condense the refrigerant received from the compressor 11. That is, the refrigerant compressed by the compressor 11 may transfer heat to the air and be condensed in the interior condenser 12. Accordingly, the interior condenser 12 may heat the air using the refrigerant compressed by the compressor 11. As the air heated by the interior condenser 12 is directed into the cabin, the cabin may be heated. The interior condenser 12 may serve as a heater core of an HVAC system of an internal combustion engine vehicle.

The heat exchanger 13 may be disposed on the downstream side of the interior condenser 12, and the heat exchanger 13 may be thermally connected to a power electronics (PE) coolant system 50. The heat exchanger 13 may be configured to transfer heat between a PE coolant circulating in the PE coolant system 50 and the refrigerant circulating in the refrigerant circulation path 30.

According to an example embodiment, the PE coolant system 50 may include a PE coolant circulation path 51 through which the PE coolant circulates, a PE component 52 fluidly connected to the PE coolant circulation path 51, a PE pump 53 forcing the PE coolant to circulate, and a PE radiator 54 fluidly connected to the PE coolant circulation path 51. The PE component may be an electric motor, an inverter, a power conversion component, and the like. The PE radiator 54 may be disposed adjacent to a front grille of the vehicle, and the PE coolant passing through the PE radiator 54 may be cooled by the ambient air forcibly blown by a cooling fan. The PE component 52 may have a coolant passage provided inside or outside thereof, and the PE coolant may pass through the coolant passage. The coolant passage of the PE component 52 may be fluidly connected to the PE coolant circulation path 51.

The heat exchanger 13 may include a first passage 13a fluidly connected to the refrigerant circulation path 30, and a second passage 13b fluidly connected to the PE coolant circulation path 51. When the temperature of the PE component increases, the PE coolant may absorb heat from the PE component so that the temperature of the PE coolant may relatively increase. The refrigerant passing through the first passage 13a of the heat exchanger 13 may exchange heat with the PE coolant passing through the second passage 13b of the heat exchanger 13.

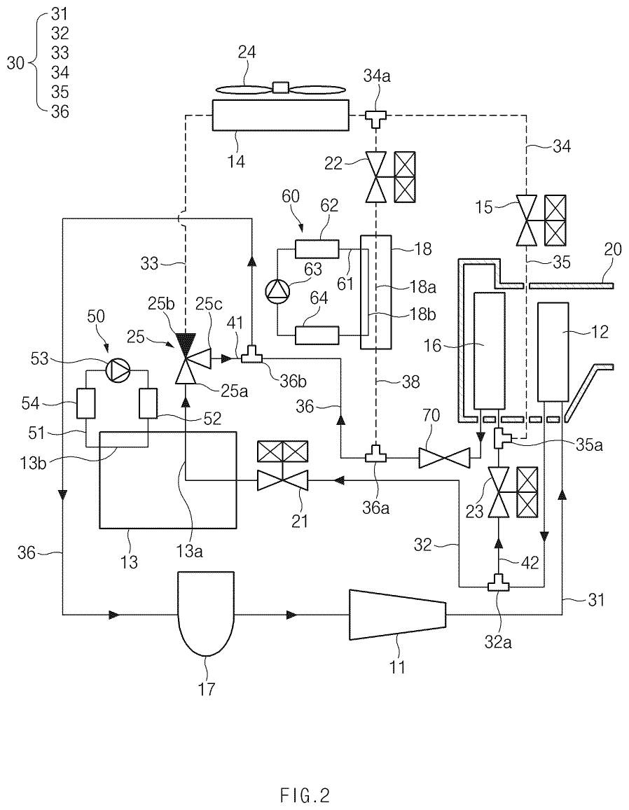

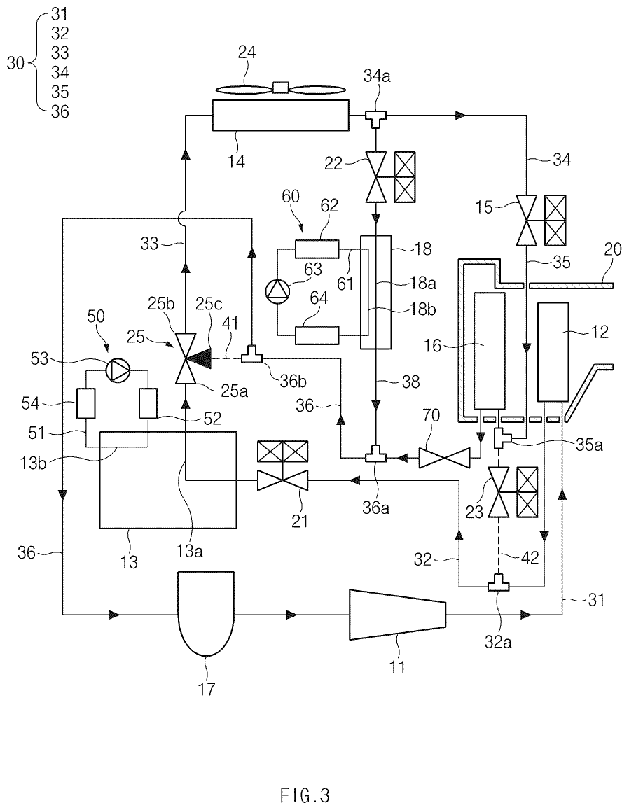

The exterior heat exchanger 14 may be disposed on the downstream side of the first passage 13a of the heat exchanger 13, and the exterior heat exchanger 14 may be disposed on the upstream side of the evaporator 16. That is, the exterior heat exchanger 14 may be disposed between the first passage 13a of the heat exchanger 13 and the evaporator 16. The exterior heat exchanger 14 may have a refrigerant passage provided therein, and the refrigerant may pass through the refrigerant passage. The exterior heat exchanger 14 may be disposed adjacent to the front grille of the vehicle, and the exterior heat exchanger 14 may be exposed to the outside. In particular, the exterior heat exchanger 14 may exchange heat with the ambient air forcibly blown by a cooling fan 24 so that a heat transfer rate between the refrigerant and the air may be further increased. Referring to FIG. 3, during a cooling operation of the HVAC system, the exterior heat exchanger 14 may be configured to condense the refrigerant received from the interior condenser 12. That is, the exterior heat exchanger 14 may serve as an exterior condenser that condenses the refrigerant by allowing the refrigerant to release heat to the ambient air during the cooling operation of the HVAC system. Referring to FIG. 2, during a heating operation of the HVAC system, the refrigerant may be blocked from flowing into the exterior heat exchanger 14.

The cooling-side expansion valve 15 may be disposed on the downstream side of the exterior heat exchanger 14, and the cooling-side expansion valve 15 may be disposed on the upstream side of the evaporator 16. That is, the cooling-side expansion valve 15 may be disposed between the exterior heat exchanger 14 and the evaporator 16. The cooling-side expansion valve 15 may adjust the flow of the refrigerant and/or the flow rate of the refrigerant into the evaporator 16. When the HVAC system operates in a cooling mode, the cooling-side expansion valve 15 may be opened to a set, selected, or predetermined opening degree to allow the refrigerant directed to the evaporator 16 to be expanded.

According to an example embodiment, the cooling-side expansion valve 15 may be a thermal expansion valve (TXV) that senses the temperature and/or pressure of the refrigerant and adjusts the opening degree of the cooling-side expansion valve 15. When the cooling-side expansion valve 15 functions as TXV, a solenoid valve may be disposed in the cooling-side expansion valve 15 or be disposed on the upstream side of the cooling-side expansion valve 15.

According to an example embodiment, the cooling-side expansion valve 15 may be an electronic expansion valve (EXV) having an actuator. The actuator may have a shaft which is movable to open or close an orifice defined in a valve body of the cooling-side expansion valve 15, and the position of the shaft may be varied depending on the rotation direction, rotation degree, and the like of the actuator, and accordingly the opening degree of the orifice of the cooling-side expansion valve 15 may be varied. A controller may control the operation of the actuator.

The evaporator 16 may be disposed on the downstream side of the cooling-side expansion valve 15, and be configured to receive the refrigerant expanded by the cooling-side expansion valve 15. The evaporator 16 may be configured to cool the air using the refrigerant received from the cooling-side expansion valve 15. That is, the refrigerant expanded by the cooling-side expansion valve 15 may absorb heat from the air and be evaporated in the evaporator 16. During the cooling operation of the HVAC system, the evaporator 16 may be configured to cool the air flowing into the cabin using the refrigerant cooled by the exterior heat exchanger 14 and expanded by the cooling-side expansion valve 15. The evaporator 16 may be disposed on the upstream side of the compressor 11, and the refrigerant discharged from the evaporator 16 may be directed to the compressor 11 through the accumulator 17.

Referring to FIG. 1, the refrigerant circulation path 30 may include a first refrigerant line 31 extending from an outlet of the compressor 11 to the interior condenser 12, a second refrigerant line 32 extending from the interior condenser 12 to the heat exchanger 13, a third refrigerant line 33 extending from the heat exchanger 13 to the exterior heat exchanger 14, a fourth refrigerant line 34 extending from the exterior heat exchanger 14 to the cooling-side expansion valve 15, a fifth refrigerant line 35 extending from the cooling-side expansion valve 15 to the evaporator 16, and a sixth refrigerant line 36 extending from the evaporator 16 to the compressor 11.

A heating-side expansion valve 21 may be disposed on the upstream side of the first passage 13a of the heat exchanger 13, and the heating-side expansion valve 21 may be disposed on the downstream side of the interior condenser 12. That is, the heating-side expansion valve 21 may be disposed between the interior condenser 12 and the heat exchanger 13. When a refrigerant subsystem operates in a heating mode to heat the cabin, the heating-side expansion valve 21 may adjust the flow of the refrigerant and/or the flow rate of the refrigerant into the first passage 13a of the heat exchanger 13, and allow the refrigerant to be expanded.

According to an example embodiment, the heating-side expansion valve 21 may be an electronic expansion valve (EXV) having an actuator. The actuator may have a shaft which is movable to open or close an orifice defined in a valve body of the heating-side expansion valve 21, and the position of the shaft may be varied depending on the rotation direction, rotation degree, and the like of the actuator, and accordingly the opening degree of the orifice of the heating-side expansion valve 21 may be varied. The controller may control the operation of the actuator. The heating-side expansion valve 21 may be a full open type EXV. When the refrigerant subsystem operates in the cooling mode, the heating-side expansion valve 21 may be fully opened to 100%. When the refrigerant passes through the heating-side expansion valve 21 in a state in which the heating-side expansion valve 21 is fully opened to 100%, the refrigerant may not be expanded by the heating-side expansion valve 21. When the refrigerant subsystem operates in the heating mode, the heating-side expansion valve 21 may be opened to a set, selected, or predetermined opening degree so that the refrigerant may be expanded by the heating-side expansion valve 21 as the refrigerant passes through the heating-side expansion valve 21.

The HVAC case 20 may have an inlet and an outlet, and the HVAC case 20 may be configured to allow the air to be directed toward the cabin of the vehicle. The evaporator 16 and the interior condenser 12 may be located inside the HVAC case 20. An electric heater such as a positive temperature coefficient (PTC) heater may be disposed on the downstream or upstream side of the interior condenser 12 in an air flow direction.

An HVAC system according to an example embodiment of the present disclosure may include a distribution line 38 fluidly connected to the refrigerant circulation path 30, and the distribution line 38 may connect an upstream point of the cooling-side expansion valve 15 and an upstream point of the compressor 11. An inlet of the distribution line 38 may be connected to a connection point 34a of the fourth refrigerant line 34 on the upstream side of the cooling-side expansion valve 15, and an outlet of the distribution line 38 may be connected to a first connection point 36a of the sixth refrigerant line 36 on the upstream side of the compressor 11. The distribution line 38 may be configured to allow at least a portion of the refrigerant discharged from the exterior heat exchanger 14 to bypass the cooling-side expansion valve 15 and the evaporator 16.

An HVAC system according to an example embodiment of the present disclosure may include the battery chiller 18 thermally connecting the distribution line 38 of the refrigerant circulation path 30 and a battery coolant circulation path 61 of a battery coolant system 60. The battery chiller 18 may be configured to transfer heat between a battery coolant circulating in the battery coolant system 60 and the refrigerant circulating in the refrigerant circulation path 30.

According to an example embodiment, the battery coolant system 60 may include the battery coolant circulation path 61 through which the battery coolant circulates, a battery 62 fluidly connected to the battery coolant circulation path 61, a battery pump 63 forcing the battery coolant to circulate, and a battery radiator 64 fluidly connected to the battery coolant circulation path 61. The battery radiator 64 may be disposed adjacent to the front grille of the vehicle, and the battery coolant passing through the battery radiator 64 may be cooled by the ambient air forcibly blown by the cooling fan. The battery 62 may have a coolant passage provided inside or outside thereof, and the battery coolant may pass through the coolant passage. The coolant passage of the battery 62 may be fluidly connected to the battery coolant circulation path 61.

The battery chiller 18 may be fluidly connected to the distribution line 38, and the battery chiller 18 may be configured to transfer heat between the refrigerant passing through the distribution line 38 and the battery coolant passing through the battery coolant circulation path 61 of the battery coolant system 60. The battery chiller 18 may include a first passage 18a fluidly connected to the distribution line 38 of the refrigerant circulation path 30, and a second passage 18b fluidly connected to the battery coolant circulation path 61 of the battery coolant system 60. The refrigerant passing through the first passage 18a may absorb heat from the battery coolant passing through the second passage 18b, and accordingly the refrigerant may be evaporated, and the battery coolant may be cooled.

A chiller-side expansion valve 22 may be disposed on the upstream side of the battery chiller 18. The chiller-side expansion valve 22 may adjust the flow of the refrigerant and/or the flow rate of the refrigerant into the battery chiller 18, and the chiller-side expansion valve 22 may be configured to allow the refrigerant received from the exterior heat exchanger 14 to be expanded. According to an example embodiment, the chiller-side expansion valve 22 may be an electronic expansion valve (EXV) having an actuator. The actuator may have a shaft which is movable to open or close an orifice defined in a valve body of the chiller-side expansion valve 22, and the position of the shaft may be varied depending on the rotation direction, rotation degree, and the like of the actuator, and accordingly the opening degree of the orifice of the chiller-side expansion valve 22 may be varied. The controller may control the operation of the actuator. The chiller-side expansion valve 22 may be a full open type EXV. As the opening degree of the chiller-side expansion valve 22 is varied, the flow rate of the refrigerant into the first passage 18a of the battery chiller 18 may be varied. As the opening degree of the cooling-side expansion valve 15 and the opening degree of the chiller-side expansion valve 22 are adjusted, the refrigerant may be distributed to the evaporator 16 and the battery chiller 18 at a set, selected, or predetermined ratio.

An HVAC system according to an example embodiment of the present disclosure may include a first bypass line 41 connecting a downstream point of the first passage 13a of the heat exchanger 13 and an upstream point of the compressor 11. An inlet of the first bypass line 41 may be fluidly connected to the third refrigerant line 33 on the upstream side of the exterior heat exchanger 14, and an outlet of the first bypass line 41 may be fluidly connected to a second connection point 36b of the sixth refrigerant line 36 on the downstream side of the evaporator 16. The first bypass line 41 may connect a point between the exterior heat exchanger 14 and the heat exchanger 13 and a point between the evaporator 16 and the compressor 11.

The first bypass line 41 may be configured to allow at least a portion of the refrigerant discharged from the first passage 13a of the heat exchanger 13 to be directed from the upstream point of the exterior heat exchanger 14 to the upstream point of the compressor 11. The refrigerant passing through the first bypass line 41 may bypass the exterior heat exchanger 14 and be directed to the compressor 11 through the accumulator 17. That is, the first bypass line 41 may be configured to allow at least a portion of the refrigerant discharged from the heat exchanger 13 to bypass the exterior heat exchanger 14. Accordingly, when the HVAC system operates in the heating mode, at least a portion of the refrigerant discharged from the first passage 13a of the heat exchanger 13 may be directed to the compressor 11 through the first bypass line 41.

An HVAC system according to an example embodiment of the present disclosure may include a control valve 25 located between the heat exchanger 13, the exterior heat exchanger 14, and the first bypass line 41. The control valve 25 may be configured to control the flow of the refrigerant (the direction of the refrigerant, the flow rate of the refrigerant, etc.) between the first passage 13a of the heat exchanger 13, the exterior heat exchanger 14, and the compressor 11. Specifically, the control valve 25 may be configured to control the flow of the refrigerant in a manner that allows the refrigerant discharged from the first passage 13a of the heat exchanger 13 to be directed to at least one of the exterior heat exchanger 14 and the compressor 11.

The control valve 25 may include an inlet port 25a communicating with the first passage 13a of the heat exchanger 13, a first outlet port 25b communicating with the exterior heat exchanger 14, and a second outlet port 25c communicating with the first bypass line 41. The control valve 25 may be switched to allow the inlet port 25a to be fluidly connected to at least one of the first outlet port 25b and the second outlet port 25c under the control of the controller.

According to an example embodiment, when the HVAC system operates in the cooling mode, the control valve 25 may be switched to allow the inlet port 25a to be fluidly connected to the first outlet port 25b under the control of the controller, and the refrigerant discharged from the first passage 13a of the heat exchanger 13 may be directed to the exterior heat exchanger 14. When the HVAC system operates in the heating mode, the control valve 25 may be switched to allow the inlet port 25a to be fluidly connected to the second outlet port 25c under the control of the controller, and the refrigerant discharged from the first passage 13a of the heat exchanger 13 may be directed to the compressor 11 through the first bypass line 41.

An HVAC system according to an example embodiment of the present disclosure may further include a second bypass line 42 configured to allow at least a portion of the refrigerant discharged from the interior condenser 12 to be directed from an upstream point of the heating-side expansion valve 21 to an upstream point of the evaporator 16. An inlet of the second bypass line 42 may be fluidly connected to a connection point 32a of the second refrigerant line 32 on the upstream side of the heating-side expansion valve 21, and an outlet of the second bypass line 42 may be fluidly connected to a connection point 35a of the fifth refrigerant line 35 on the upstream side of the evaporator 16. The second bypass line 42 may connect a point between the interior condenser 12 and the heat exchanger 13 and a point between the cooling-side expansion valve 15 and the evaporator 16. Accordingly, the refrigerant passing through the second bypass line 42 may bypass the heating-side expansion valve 21 and the heat exchanger 13, and be directed to the evaporator 16. That is, the second bypass line 42 may be configured to allow at least a portion of the refrigerant discharged from the interior condenser 12 to bypass the heating-side expansion valve 21 and the heat exchanger 13. When the HVAC system operates in the heating mode, at least a portion of the refrigerant discharged from the interior condenser 12 may be directed to the evaporator 16 through the second bypass line 42.

An HVAC system according to an example embodiment of the present disclosure may include an auxiliary expansion valve 23 disposed on the second bypass line 42. The auxiliary expansion valve 23 may be disposed on the upstream side of the evaporator 16 on the second bypass line 42. The auxiliary expansion valve 23 may adjust the flow of the refrigerant and/or the flow rate of the refrigerant into the evaporator 16, and the auxiliary expansion valve 23 may be configured to allow the refrigerant directed to the evaporator 16 to be expanded.

According to an example embodiment, the auxiliary expansion valve 23 may be an electronic expansion valve (EXV) having an actuator. The actuator may have a shaft which is movable to open or close an orifice defined in a valve body of the auxiliary expansion valve 23, and the position of the shaft may be varied depending on the rotation direction, rotation degree, and the like of the actuator, and accordingly the opening degree of the orifice of the auxiliary expansion valve 23 may be varied. The controller may control the operation of the actuator. As the opening degree of the auxiliary expansion valve 23 is varied, the flow rate of the refrigerant into the evaporator 16 may be varied. The auxiliary expansion valve 23 may be a full open type EXV. When the HVAC system operates in the heating mode and an after-blow mode, the auxiliary expansion valve 23 may be fully opened to 100%. When the refrigerant passes through the auxiliary expansion valve 23 in a state in which the auxiliary expansion valve 23 is fully opened to 100%, the refrigerant may not be expanded by the auxiliary expansion valve 23. When the HVAC system operates in the cooling mode, the auxiliary expansion valve 23 may be fully closed.

An HVAC system according to an example embodiment of the present disclosure may include an adjusting valve 70 disposed between the evaporator 16 and the compressor 11. The adjusting valve 70 may be disposed on the downstream side of the evaporator 16, and the adjusting valve 70 may be configured to adjust the flow rate of the refrigerant from the evaporator 16 into the compressor 11. The adjusting valve 70 may be disposed on the upstream side of the first connection point 36a of the sixth refrigerant line 36, and the distribution line 38 may be connected to the first connection point 36a of the sixth refrigerant line 36 so that the refrigerant discharged from the first passage 18a of the battery chiller 18 and the refrigerant discharged from the evaporator 16 may join at the first connection point 36a of the sixth refrigerant line 36.

The adjusting valve 70 may be configured to adjust the flow rate of the refrigerant discharged from the evaporator 16 by adjusting the opening degree of an orifice defined in a valve body thereof. Specifically, when the HVAC system operates in the heating mode, the opening degree of the adjusting valve 70 may be adjusted so that the flow rate of the refrigerant discharged from the evaporator 16 may be adjusted. When the HVAC system operates in the cooling mode, the adjusting valve 70 may be fully opened to 100%.

The controller may be configured to control respective operations of the compressor 11, the cooling-side expansion valve 15, the heating-side expansion valve 21, the chiller-side expansion valve 22, the auxiliary expansion valve 23, the adjusting valve 70, and the like, and thus the overall operation of the HVAC system may be controlled by the controller.

FIG. 2 illustrates the flow of the refrigerant when the HVAC system according to an example embodiment of the present disclosure operates in the heating mode. Referring to FIG. 2, as the compressor 11 operates at set, selected, or predetermined RPM, the compressor 11 may compress the refrigerant, and the refrigerant discharged from the outlet of the compressor 11 may be in high temperature and high pressure state. The refrigerant compressed by the compressor 11 may be directed to the interior condenser 12, and the interior condenser 12 may be cooled by the air passing through the HVAC case 20 so that the refrigerant passing through the interior condenser 12 may be condensed by the air, and the air may be heated.

The refrigerant discharged from the interior condenser 12 may be directed to the heating-side expansion valve 21, and the heating-side expansion valve 21 may be opened to a set, selected, or predetermined opening degree when the HVAC system operates in the heating mode so that the refrigerant passing through the heating-side expansion valve 21 may be expanded, and the expanded refrigerant may pass through the first passage 13a of the heat exchanger 13. The refrigerant passing through the first passage 13a of the heat exchanger 13 may absorb heat from the coolant passing through the second passage 13b of the heat exchanger 13, and accordingly the refrigerant may be evaporated in the heat exchanger 13.

When the HVAC system operates in the heating mode, the control valve 25 may be switched to allow the inlet port 25a to be fluidly connected to the second outlet port 25c under the control of the controller, and accordingly the refrigerant discharged from the first passage 13a of the heat exchanger 13 may be directed to the compressor 11 through the first bypass line 41.

When the HVAC system operates in the heating mode, the auxiliary expansion valve 23 may be fully opened, and at least a portion of the refrigerant discharged from the interior condenser 12 may pass through the auxiliary expansion valve 23. The refrigerant passing through the fully opened auxiliary expansion valve 23 may not be expanded in the auxiliary expansion valve 23. The refrigerant discharged from the auxiliary expansion valve 23 may pass through the evaporator 16. As the adjusting valve 70 is opened to a set, selected, or predetermined opening degree, the flow rate of the refrigerant discharged from the evaporator 16 may be adjusted, and the refrigerant discharged from the adjusting valve 70 and the refrigerant discharged from the second outlet port 25c of the control valve 25 may join at the second connection point 36b of the sixth refrigerant line 36, and then be directed to the compressor 11 through the accumulator 17.

In an HVAC system according to the related art, when the HVAC system operates in a heating mode in a state in which an ambient temperature is relatively low, a refrigerant may fail to sufficiently absorb heat from a PE coolant. Because the refrigerant is not sufficiently evaporated in a heat exchanger, a suction pressure of a compressor may be lowered below a threshold pressure (for example, 0.2 kgf/cm₂). When the suction pressure of the compressor is lower than the threshold pressure, efficiency of the compressor may be reduced, and accordingly RPM of the compressor may be lowered below threshold RPM or the compressor may be stopped due to a low pressure protection function. As a result, the flow rate of the refrigerant may be relatively reduced, and the temperature of the refrigerant discharged from the compressor may be relatively lowered so that the coefficient of performance (COP) of the HVAC system may be degraded.

According to an example embodiment of the present disclosure, when the HVAC system operates in the heating mode, the auxiliary expansion valve 23 may be fully opened, and the pressure and temperature of the refrigerant discharged from the evaporator 16 may be higher than the pressure and temperature of the refrigerant discharged from the first passage 13a of the heat exchanger 13. After the refrigerant discharged from the evaporator 16 and the refrigerant discharged from the first passage 13a of the heat exchanger 13 join, the refrigerant may be directed to the compressor 11, and thus a suction pressure of the compressor 11 may be maintained to be higher than a threshold pressure. Because the suction pressure of the compressor 11 can be relatively high, RPM of the compressor 11 may be appropriately controlled to meet a target heating temperature of the cabin set by a user, and thus the heating performance of the HVAC system may be improved with the use of the refrigerant.

FIG. 3 illustrates the flow of the refrigerant when the HVAC system according to an example embodiment of the present disclosure operates in the cooling mode. Referring to FIG. 3, as the compressor 11 operates at set, selected, or predetermined RPM, the compressor 11 may compress the refrigerant, and the refrigerant discharged from the outlet of the compressor 11 may be in high temperature and high pressure state. The refrigerant compressed by the compressor 11 may pass through the interior condenser 12.

When the HVAC system operates in the cooling mode, the heating-side expansion valve 21 may be fully opened so that the refrigerant passing through the heating-side expansion valve 21 may not be expanded, and the refrigerant discharged from the heating-side expansion valve 21 may be directed to the first passage 13a of the heat exchanger 13. The refrigerant passing through the first passage 13a of the heat exchanger 13 may exchange heat with the coolant passing through the second passage 13b of the heat exchanger 13.

When the HVAC system operates in the cooling mode, the control valve 25 may be switched to allow the inlet port 25a to be fluidly connected to the first outlet port 25b under the control of the controller, and accordingly the refrigerant discharged from the first passage 13a of the heat exchanger 13 may not be directed to the first bypass line 41, but may be directed to the exterior heat exchanger 14. The refrigerant discharged from the exterior heat exchanger 14 may be directed to the cooling-side expansion valve 15. As the cooling-side expansion valve 15 is opened to a set, selected, or predetermined opening degree, the refrigerant may be expanded by the cooling-side expansion valve 15. The refrigerant discharged from the cooling-side expansion valve 15 may pass through the evaporator 16, and the refrigerant discharged from the evaporator 16 may be directed to the compressor 11 through the accumulator 17.

When the HVAC system operates in the cooling mode, the adjusting valve 70 may be fully opened.

As the chiller-side expansion valve 22 is opened to a set, selected, or predetermined opening degree, a portion of the refrigerant discharged from the exterior heat exchanger 14 may pass through the chiller-side expansion valve 22, and it may be expanded by the chiller-side expansion valve 22. The refrigerant passing through the first passage 18a of the battery chiller 18 may absorb heat from the battery coolant passing through the second passage 18b, and accordingly the refrigerant may be evaporated, and the battery coolant may be cooled. The refrigerant discharged from the first passage 18a of the battery chiller 18 may be directed to the compressor 11 through the accumulator 17.

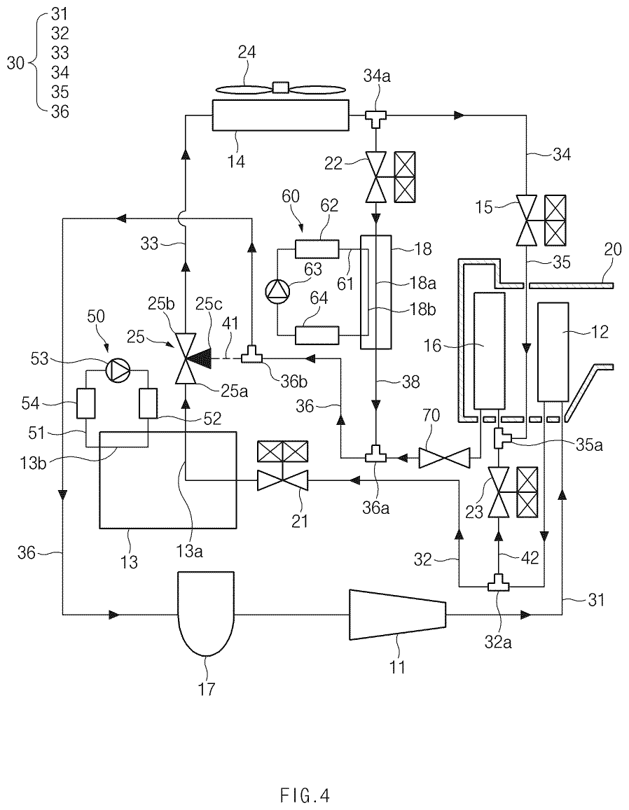

FIG. 4 illustrates the flow of the refrigerant when the HVAC system according to an example embodiment of the present disclosure operates in an after-blow mode. In the after-blow mode, an air blower of the HVAC case 20 may operate for a set, selected, or predetermined period of time when the HVAC system stops operating in the cooling mode so that the evaporator 16 of the HVAC case 20 may be dried by the air blown by the air blower.

Referring to FIG. 4, when the HVAC system operates in the after-blow mode, the auxiliary expansion valve 23 may be fully opened so that the refrigerant discharged from the interior condenser 12 may pass through the evaporator 16, and the evaporator 16 may be quickly dried by the refrigerant discharged from the interior condenser 12. Accordingly, the operating time of the HVAC system in the after-blow mode may be significantly reduced.

As set forth above, an HVAC system according to example embodiments of the present disclosure may be designed to improve the heating performance using the circulation of the refrigerant by preventing the suction pressure of the compressor from being lowered below the threshold pressure when the HVAC system operates in the heating mode in a relatively low ambient temperature condition. By minimizing the use of the electric heater, waste of electric energy may be reduced and electric efficiency of the electric vehicle may be improved using an embodiment of the present disclosure.

According to example embodiments of the present disclosure, when an HVAC system operates in the heating mode, the auxiliary expansion valve may be fully opened, and the pressure and temperature of the refrigerant discharged from the evaporator may be higher than the pressure and temperature of the refrigerant discharged from the first passage of the heat exchanger. After the refrigerant discharged from the evaporator and the refrigerant discharged from the first passage of the heat exchanger join, the refrigerant may be directed to the compressor, and thus the suction pressure of the compressor may be maintained to be higher than the threshold pressure. Because the suction pressure of the compressor is relatively high, the RPM of the compressor may be appropriately controlled to meet a target heating temperature of the cabin set by the user, and thus the heating performance of the HVAC system may be improved with the use of the refrigerant using an embodiment of the present disclosure.

A number of embodiments have been disclosed herein. It can be understood that various features of the different embodiments can be combined.

Hereinabove, although the present disclosure has been described with reference to example embodiments and the accompanying drawings, the present disclosure is not necessarily limited thereto, but may be variously modified and altered by those skilled in the art to which the present disclosure pertains, and equivalents thereof, without departing from the spirit and scopes of the present disclosure claimed in the following claims.

What is claimed is:

1. A vehicle heating, ventilation, and air conditioning (HVAC) system, comprising:
a compressor;
an interior condenser disposed on a compressor downstream side of the compressor;
a heat exchanger disposed on an interior-condenser downstream side of the interior condenser, wherein the heat exchanger is configured to transfer heat between a refrigerant and a coolant circulating in a coolant system;
an evaporator disposed on a heat-exchanger downstream side of the heat exchanger, and disposed on a compressor upstream side of the compressor;
a first bypass line connecting a heat-exchanger downstream point of the heat exchanger and a compressor upstream point of the compressor; and
a second bypass line connecting an interior-condenser downstream point of the interior condenser and an evaporator upstream point of the evaporator.

2. The vehicle HVAC system according to claim 1, further comprising an exterior heat exchanger disposed between the heat exchanger and the evaporator, wherein the exterior heat exchanger is configured to transfer heat between the refrigerant and ambient air, wherein the first bypass line is configured to allow at least a portion of the refrigerant discharged from the heat exchanger to be directed from an exterior-heat-exchanger upstream point of the exterior heat exchanger to the compressor upstream point of the compressor.

3. The vehicle HVAC system according to claim 2, further comprising:
a cooling-side expansion valve disposed between the exterior heat exchanger and the evaporator; and
a heating-side expansion valve disposed between the heat exchanger and the interior condenser, wherein the second bypass line is configured to allow at least part of the refrigerant discharged from the interior condenser to be directed from a heating-side-expansion-valve upstream point of the heating-side expansion valve to the evaporator upstream point of the evaporator.

4. The vehicle HVAC system according to claim 2, further comprising a control valve configured to control a flow of the refrigerant in a manner that allows the refrigerant discharged from the heat exchanger to be directed to at least one of the exterior heat exchanger and the compressor.

5. The vehicle HVAC system according to claim 4, wherein the control valve includes an inlet port communicating with the heat exchanger, a first outlet port communicating with the exterior heat exchanger, and a second outlet port communicating with the first bypass line.

6. The vehicle HVAC system according to claim 5, wherein the control valve is configured to be switched to allow the inlet port to be fluidly connected to at least one of the first outlet port and the second outlet port.

7. The vehicle HVAC system according to claim 5, wherein the control valve is configured to be switched to allow the inlet port to be fluidly connected to the second outlet port based on the HVAC system operating in a heating mode.

8. The vehicle HVAC system according to claim 1, further comprising an auxiliary expansion valve disposed on the second bypass line, wherein the auxiliary expansion valve is disposed on an evaporator upstream side of the evaporator on the second bypass line.

9. The vehicle HVAC system according to claim 8, wherein the auxiliary expansion valve is configured to be fully opened based on the HVAC system operating in a heating mode.

10. The vehicle HVAC system according to claim 1, further comprising an adjusting valve disposed between the evaporator and the compressor, wherein the adjusting valve is configured to be adjust an opening degree thereof to adjust a flow rate of the refrigerant discharged from the evaporator.

11. The vehicle HVAC system according to claim 1, wherein the coolant system is a power electronics (PE) coolant system, and wherein the heat exchanger comprises:
a first passage through which the refrigerant passes; and
a second passage through which the coolant passes, wherein the second passage of the heat exchanger is fluidly connected to the PE coolant system.

12. A vehicle heating, ventilation, and air conditioning (HVAC) system, comprising:
a power electronics (PE) cooling system;
a compressor;
an interior condenser downstream of the compressor;
an evaporator;
a PE heat exchanger thermally connected to the PE cooling system, wherein the PE heat exchanger is downstream of the interior condenser;
an exterior heat exchanger, wherein the exterior heat exchanger is downstream of the PE heat exchanger, wherein the exterior heat exchanger is upstream of the evaporator;
a cooling-side expansion valve 15 disposed between the exterior heat exchanger and the evaporator;
a refrigerant circulation line configured to flow a refrigerant through the HVAC system, wherein the refrigerant circulation line comprises:
a first refrigerant line extending from a compressor outlet of the compressor to the interior condenser,
a second refrigerant line extending from the interior condenser to the PE heat exchanger,
a third refrigerant line extending from the PE heat exchanger to the exterior heat exchanger,
a fourth refrigerant line extending from the exterior heat exchanger to the cooling-side expansion valve,
a fifth refrigerant line extending from the cooling-side expansion valve to the evaporator,
a sixth refrigerant line extending from the evaporator to a compressor inlet of the compressor,
a seventh refrigerant line extending through the PE heat exchanger, and
a first bypass refrigerant line having a first first-bypass-refrigerant-line-end connected to a first connection point on the sixth refrigerant line;
a control valve located between the PE heat exchanger, the exterior heat exchanger, and the first bypass refrigerant line, wherein the control valve is connected to a second first-bypass-refrigerant-line end of the first bypass line, wherein the third refrigerant line extends from the control valve to the exterior heat exchanger, and wherein the control valve is configured to control flow of the refrigerant discharged from the seventh refrigerant line of the PE heat exchanger to be directed to at least one of the exterior heat exchanger via the third refrigerant line and the compressor via the six refrigerant line.

13. The vehicle HVAC system according to claim 12, wherein the refrigerant circulation line further comprises a second bypass refrigerant line having a first second-bypass-refrigerant-line end connecting to a second connection point on the second refrigerant line between the interior condenser and the PE heat exchanger, and wherein the second bypass refrigerant line has a second second-bypass-refrigerant-line end connecting to a third connection point on the fifth refrigerant line between the cooling-side expansion valve and the evaporator.

14. The vehicle HVAC system according to claim 13, further comprising an auxiliary expansion valve on the second bypass refrigerant line, wherein the auxiliary expansion valve is configured to adjust flow of the refrigerant into the evaporator via the third connection point on the fifth refrigerant line from the interior condenser via the second connection point on the second refrigerant line.

15. The vehicle HVAC system according to claim 12, further comprising a heating-side expansion valve on the second refrigerant line between the interior condenser and the PE heat exchanger.

16. The vehicle HVAC system according to claim 12, further comprising an HVAC case, wherein the interior condenser is at least partially in the HVAC case, and wherein the evaporator at least partially in the HVAC case.

17. The vehicle HVAC system according to claim 12, further comprising a battery chiller, wherein the refrigerant circulation line further comprises a distribution refrigerant line connected to the fourth refrigerant line between the exterior heat exchanger to the cooling-side expansion valve, connected to the sixth refrigerant line, and extending through the battery chiller.

18. A vehicle heating, ventilation, and air conditioning (HVAC) system, comprising:
a power electronics (PE) cooling system;
a compressor;
an interior condenser downstream of the compressor;
an evaporator;
a PE heat exchanger thermally connected to the PE cooling system, wherein the PE heat exchanger is downstream of the interior condenser;
an exterior heat exchanger, wherein the exterior heat exchanger is downstream of the PE heat exchanger, wherein the exterior heat exchanger is upstream of the evaporator;
a cooling-side expansion valve 15 disposed between the exterior heat exchanger and the evaporator;
a refrigerant circulation line configured to flow a refrigerant through the HVAC system, wherein the refrigerant circulation line comprises:
a first refrigerant line extending from a compressor outlet of the compressor to the interior condenser,
a second refrigerant line extending from the interior condenser to the PE heat exchanger,
a third refrigerant line extending from the PE heat exchanger to the exterior heat exchanger,
a fourth refrigerant line extending from the exterior heat exchanger to the cooling-side expansion valve,
a fifth refrigerant line extending from the cooling-side expansion valve to the evaporator,
a sixth refrigerant line extending from the evaporator to a compressor inlet of the compressor, and
a seventh refrigerant line extending through the PE heat exchanger,
a first bypass refrigerant line having a first first-bypass-refrigerant-line-end connected to a first connection point on the sixth refrigerant line, and
a second bypass refrigerant line having a first second-bypass-refrigerant-line end connecting to a second connection point on the second refrigerant line between the interior condenser and the PE heat exchanger, and wherein the second bypass refrigerant line has a second second-bypass-refrigerant-line end connecting to a third connection point on the fifth refrigerant line between the cooling-side expansion valve and the evaporator; and
a control valve located between the PE heat exchanger, the exterior heat exchanger, and the first bypass refrigerant line, wherein the control valve is connected to a second first-bypass-refrigerant-line end of the first bypass line, wherein the third refrigerant line extends from the control valve to the exterior heat exchanger, and wherein the control valve is configured to control flow of the refrigerant discharged from the seventh refrigerant line of the PE heat exchanger to be directed to at least one of the exterior heat exchanger via the third refrigerant line and the compressor via the six refrigerant line.

19. The vehicle HVAC system according to claim 18, further comprising an auxiliary expansion valve on the second bypass refrigerant line, wherein the auxiliary expansion valve is configured to adjust flow of the refrigerant into the evaporator via the third connection point on the fifth refrigerant line from the interior condenser via the second connection point on the second refrigerant line.

20. The vehicle HVAC system according to claim 19, further comprising a heating-side expansion valve on the second refrigerant line between the second connection point on the second refrigerant line and the PE heat exchanger.
